(19) United States
(12) Patent Application Publication
(10) Pub. No.: US 2014/0304607 A1
(43) Pub. Date: Oct. 9, 2014

(54) Monitoring System

(71) Applicants: Michael Lyle Eglington, San Bruno, CA (US); Rudolph Felix Gutt, Vienna, VA (US)

(72) Inventors: Michael Lyle Eglington, San Bruno, CA (US); Rudolph Felix Gutt, Vienna, VA (US)

(21) Appl. No.: 13/857,339

(22) Filed: Apr. 5, 2013

(51) Int. Cl. H04L 12/24; H04L 29/06

(52) U.S. Cl. CPC H04L 41/22; H04L 65/403
USPC 715/735; 715/753

(57) ABSTRACT

A configurable system that employs a processing unit, such as a computer, to which one or more responders, such as a keyboard and a mouse, through which a user interacts with the processing unit. While each of the responders is utilized by the user for its designed primary function, its activity is also used for monitoring whether the individual is interacting with the processing unit within expected bounds.

### BACKGROUND OF THE INVENTION

This invention relates to monitoring at-home activities of individuals and, more particularly, to a system and method for monitoring an individual's well being by identifying and reporting unexpected behavior.

It is not unusual nowadays for people to live independently even when they are advanced in years, infirm, and their loved ones live far away. Often, one of the loved ones assumes the burden of making sure that the living-alone person (LA individual) has his or her physical needs attended to, and that prompt action is taken when this person is in distress. In a sense, the person who had taken on the burden is a pseudo-parent (herein, SP party).

Because the SP party is often far removed from the LA individual, and sometimes there is no SP party at all, there has been a need for remote monitoring of LA individuals.

To satisfy this need, systems have been developed to enable an LA individual to contact medical professionals from his or her home in case of a medical emergency. In a number of such prior art systems the LA individual is equipped with an emergency call button that initiates a cal or otherwise signals an emergency call center. The concept of such a system is that if the LA individual is in distress, he or she can press the emergency call button and the call center will respond, ready to enlist the services of pre-specified emergency service providers (e.g., doctor, ambulance, police, etc.). In addition to calling upon emergency services, the emergency call center often also informs a designated person (typically, the SP party). Unfortunately, in some cases, the individual is unable to press the emergency call button, such as when an individual has fallen and cannot reach the button, or for some reason is unconscious.

Somewhat more complex systems have also been designed to monitor medication compliance or check health characteristics of an individual, such as heart rate, body temperature, blood chemistry, blood pressure, respiration, and the like. In these systems the individual has to provide data periodically, such as by telephoning a monitoring center to provide health information to the center, or by logging into a web site or other data collection system.

A system that is qualitatively somewhat different is described in U.S. Pat. No. 6,445,298 where a motion detector ascertains the movement or non-movement of the LA individual and this information is reported to a central monitoring station. The difference between the U.S. Pat. No. 6,445,298 and the above-described systems is that a motion detector is an opportunistic sensor, as compared to the medical sensors that are focused on the individual, or the button which responds to a conscious, volitional, action by the individual and is, therefore, a responder.

In U.S. Pat. No. 7,091,865, opportunistic sensors that are distributed around the home collect data on activity in the home. The primary contribution of the U.S. Pat. No. 7,091,865 is that data is communicated to a remote monitoring center and collated in a database according to applicable time slots (e.g., hour long). Historical activity is used to determine whether a new data point unreasonably exceeds historical activity bounds, in which case an alert message is issued indicating that the activity is unusual.

Similarly, Published US Patent application 2005/0131736 monitors a sensor that is activated by an individual, the activation is recorded, and a determination is made—using histogram analysis—whether the individual's behavior as reflected by the sensor's information is routine.

The above-described systems are effective, but they offer very little control to the SP party.

Additionally, perhaps because the LA individual is often elderly, infirm, and lives alone, the social interactions of the typical LA individual are often limited, and that gives rise to a sense of isolation and loneliness.

Clearly, a need exists for effective monitoring of the LA individual and for enhancing the quality of life by enhancing the social interactions of the LA individual.

### BRIEF DESCRIPTION OF THE DRAWINGS

FIG. 1 depicts an arrangement that includes a system (10) in accord with the principles disclosed herein;

FIG. 2 illustrates a display that may be visible on the monitor of system 10;

FIG. 3 depicts the method executed in system 10;

FIG. 4 shows an interaction of an embodiment in accord with the principles disclosed herein that employs a server 30 for configuring system 10; and

FIG. 5 shows an interaction of an embodiment for configuring system 10 without use of server 30.

### SUMMARY

The above-mentioned need for effective monitoring is satisfied and an advance in the art is realized with a configurable system that is installed in the LA individual's home. This system employs one or more responders that have a designed primary function and, while each is used in its primary function, it is also used for monitoring the well being of the LA individual. In one embodiment, the system of this invention is a personal computer, with responders taken from a set that includes a keyboard and a mouse, a touch screen, a microphone, a camera, and an infra-red (IR) detector. One or more of the connected responders is employed in a process that determines the well being of the LA individual. The process of determining the well being of the individual may be similar to the processes described in the aforementioned U.S. Pat. No. 7,091,865 and Published US Patent application 2005/0131736.

The above-mentioned need for social interactions is satisfied by configuring the computer with one or more social interaction programming modules. Advantageously, the user interface that is installed in the computer is alterably configured to the level of expertise that the LA individual possesses with computers.

Advantageously, the system is remotely configurable. In one embodiment, the system is configured (and at time reconfigured) by a central monitoring site. In such an embodiment, the configuration that is installed in the LA individual's computer may be alterable by the SP Party through an interaction with the central monitoring site. In a second embodiment, the system is configured (and at times reconfigured) by the SP Party directly, through the Internet, or locally.

### DETAILED DESCRIPTION

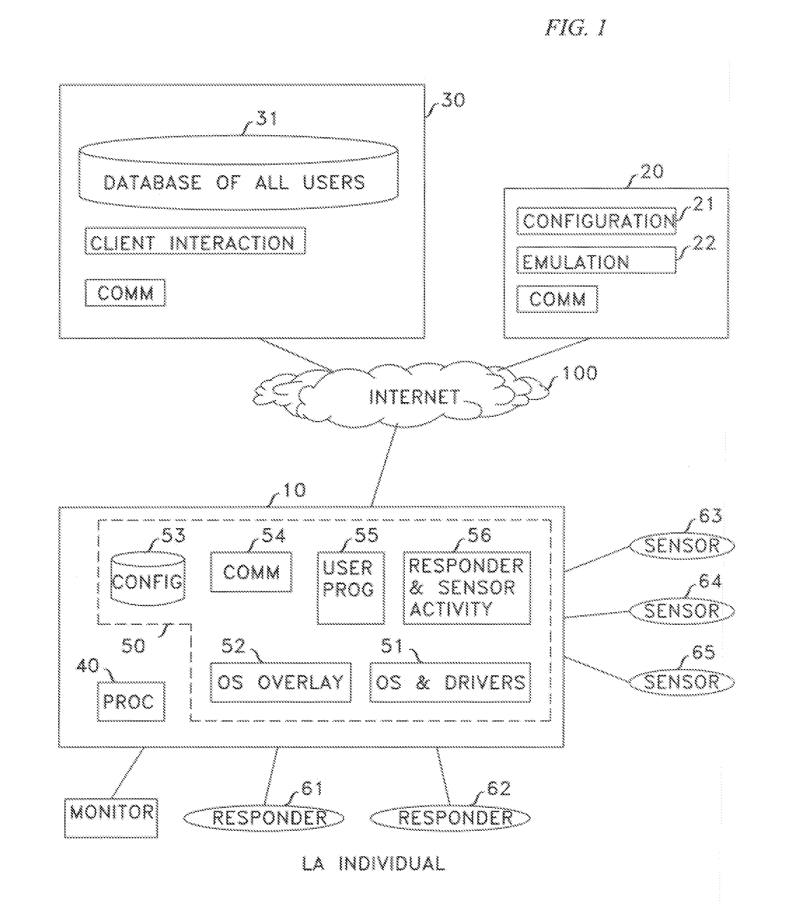

FIG. 1 presents a diagram of an illustrative system in accord with the principles disclosed herein, which includes computer 10 at the home of the LA individual, computer

Computer 10 includes processor 40 and memory that stores data and program modules. Computer 10 may be a conventional personal computer that operates pursuant to any selected operating system 51, and the associated drivers for responders 61 and 62 (e.g., keyboard and mouse)

In the embodiment illustrated in FIG. 1, computer 10 includes program module 52 that effectively “sits on top” of the operating system and presents to the LA individual only those capabilities that module 52 deems necessary, and presents those capabilities via a look-and-feel interface that module 52 specifies. In other words, module 52 has the ability to make computer 10 offer as many or as few capabilities as desired, and those capabilities are presented in whatever way module 52 dictates. The interface that a particular LA individual is presented by module 52—both in terms of the applications and in terms of the look-and-feel—is dictated by data in database 53. That data is downloaded to computer 10 by server 30 with the help of communications module 54. (In some embodiments, a particular input string from the keyboard terminates execution of the overlay module, leaving computer 10 operating under its native operating system.)

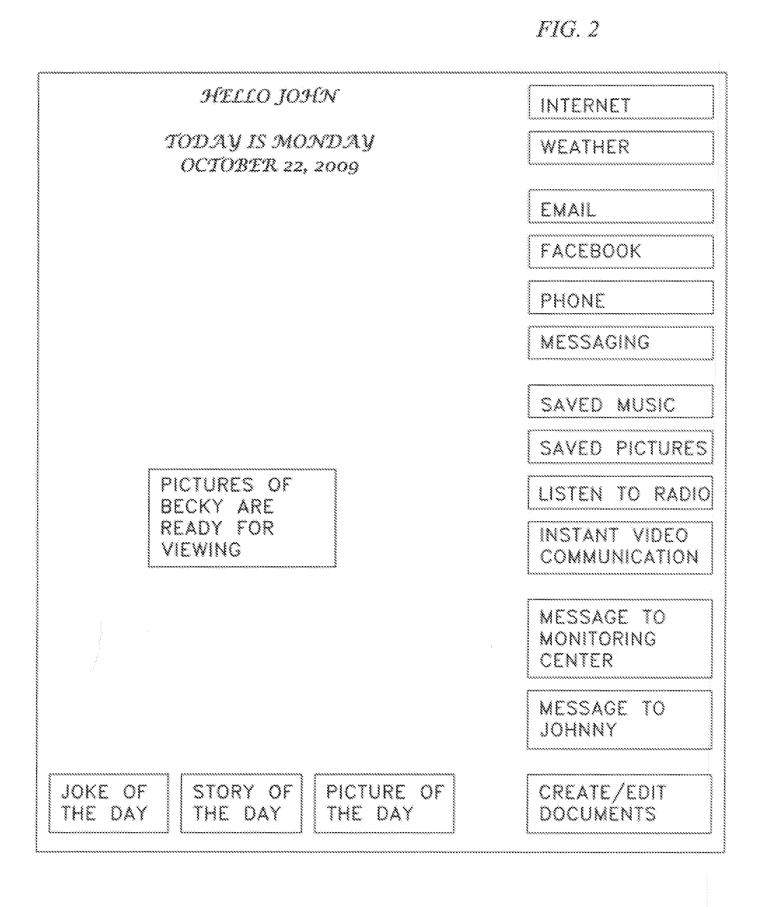

FIG. 2 depicts what a computer display monitor that is associated with the FIG. 1 system, configured for a particular LA individual, and that individual's level of computer savvy. Illustratively, the information is presented as a collection of “buttons” which, when pointed to and clicked by a mouse responder, activates the application that is described by the button's label. Thus, for example, when the LA individual points to and clicks on the “listen to radio,” a web-based radio station of a particular genre (specified by database 53) is turned on. Although FIG. 2 shows rectangular “buttons” small images (icons) may be used.

It may be noted that some of the applications have no need to interact with the Internet (such as “create/edit documents,” “saved music,” and “saved pictures”), some of the applications are relatively standard applications that involve interaction with the Internet (such as “Internet,” “Facebook,” and “Weather”), and some applications are very specific to the LA individual (such as “Message to Johnny”). Of the applications that involve interactions with the Internet, there is a whole class of social networking applications, such as Facebook, Twitter, MySpace, LinkedIn, etc., which LA individuals often find very appealing because they involve interactions with individuals rather than with inanimate websites. FIG. 2 also depicts a “push” capability, where the message in the center of the monitor informs the LA individual that information was downloaded to computer 10 (“Pictures of Becky are ready for viewing”).

Of course, each of the applications that are shown on the monitor resides in memory 50 and, more specifically, within programs grouping 55.

Optionally, in addition to the responders that are connected to computer 10, computer 10 includes sensors 63, 64 and 65. These may be opportunistic sensors, such as motion detectors, intrusion sensors, and the like, and/or other types of sensors, such as fire, or medical condition sensors.

One important objective of the FIG. 2 system is to send an alert message when the behavior of the LA individual is out of an accepted norm. To that end a norm needs to be defined; and that norm is specific to the LA individual and to how that individual interacts with his or her home environment. This norm is defined by information that is stored in database 53, and the determination as to whether the behavior of the LA individual is outside the norm is made by software module 56.

The information that defines behavior that is within or outside the norm is, effectively, a set of rules, and those rules are associated with the specific responders and sensors that computer 10 has. At least some of those rules are may be altered from time to time, either manually or in response to automated data analysis to correspond to the particular patterns of behavior that the LA individual has. For example, if there is a fire alarm sensor that connects to computer 10, computer 10 would have a rule relative thereto which, illustratively, is to respond to the arrival of an alarm signal from the sensor by immediately sending an alarm message to the fire department, to SP 20, and perhaps also to other individuals who are concerned about the LA individual. When a computer mouse that is associated with computer 10 is one of the responders, the rule for the mouse may be that an alarm message is sent out to central monitoring server 30 or to SP party 20, or both, if the mouse is not clicked on any screen “button” within a chosen time span; for example, 20 hours. Respectively, these examples represent fixed rules that, most likely will not be altered and, perhaps, are made not alterable, and rules that are configurable. It is understood that the configurable rules includes self-learning rules, where the thresholds are based on analysis of past behavior of the LA individual. That analysis can create new rules rather than just alter thresholds. For example, if the LA individual's habit is to execute a particular program at about 10 pm and shortly thereafter the individual is detected in his/her bedroom and there is no further activity for the night, a rule can be created (by a program that seeks patterns), for example, to send an alarm if that program is executed later than 9:45 pm but the individual is not detected in his/her bedroom within 15 minutes.

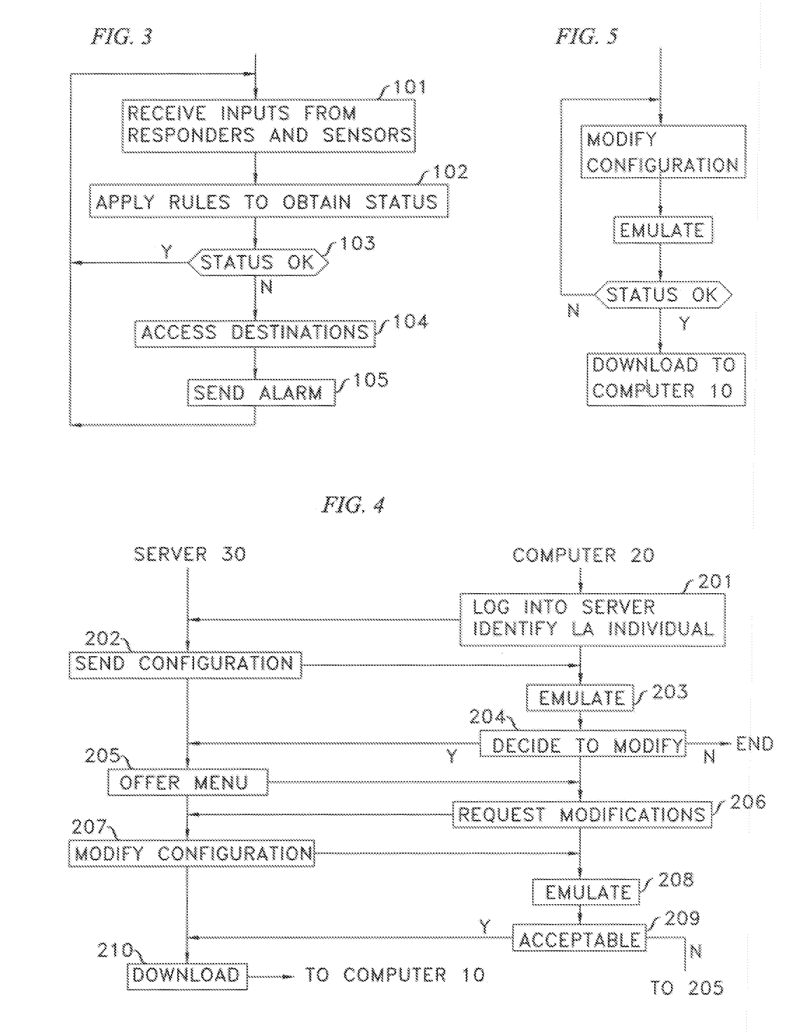

FIG. 3 is a flowchart of the process within computer 10 that sends an alert message when appropriate. In step 101 signals from responders and sensors are received. Those signals are different for different responders and sensors. For example, for a keyboard, any all keystrokes constitute a trigger signal; in a touch-sensitive screen, any momentary touching of the screen constitutes a trigger signal; in a motion detection sensor, and movement that is detected by the signal is a trigger signal, etc.

From step 101 control passes to step 102 where the signals are processed as specified by module 56 to determine whether the LA individual is likely to be OK, and control passes to step 103. It is noted that the processing carried out by module 56 is, at least in connection with most of the responders, sensitive to passage of time. That is, the status that is developed by the processing can change whether or not a trigger signal arrives. Indeed, in most circumstances where the status changes from “ok” to “not ok” it is because of an absence of a trigger signal. Therefore, the passage of control from step 102 to 103 occurs repeatedly, and in most embodiments periodically.

Step 103 determines whether the status is “ok” or not. When status is “ok” control returns to step 101. Otherwise control passes to step 104, which formulates an alarm message and queries database 53 for the address of a party to whom the alert message is to be sent. Database 53 may have more than one addressee, depending on the nature of the alarm message. Those addressees may be the central monitoring server, the SP party (i.e., computer 20) or some other party (e.g., fire department, police, kin of the LA individual, etc.). Following the sending of the alarm message, control returns to step 101.

In accordance with the FIG. 1 embodiment, the information that resides in database 53 is fashioned and downloaded to database 53 by server 30, but this fashioning is under direction of SP computer 20. To elaborate, the party that owns server 30 is in the business of serving as the technical and responder agent for SP parties for the benefit of LA individuals, effectively standing in the shoes of the respective SP parties, who are not savvy enough technically to create and to download the above disclosed program modules of computer 10, or who are not able to respond as quickly to alarm messages as they believe they should. Of course, an embodiment that dispenses with server 30 is possible, without departing from the spirit and scope of this invention. Such an embodiment, for example, relies on direct communication between computers 10 and 20; both for configuring and for reporting alarms.

FIG. 4 presents a flow chart of a process that involves (primarily) computer 20 and server 30. When the SP party wishes to review and perhaps modify the operation of computer 10 the party logs into server 30 at step 201 and indentifies computer 10. Server 30 contains database 31 that maintains information about SP computer 20 and about the configuration of LA computer 10 (as well as about other SP and LA computers). Control then passes to step 202, which sends the configuration information of computer 10 to computer 20. Computer 20 stores this configuration information is storage area 21 and, when instructed by the SP party, executes emulation module 22. Module 22 duplicates on computer 20 the experience that computer 10 offers at the home of the LA individual. The emulation enables the SP party to assess whether the environment offered to the LA individual at computer 10 is adequate.

Following the emulation, at step 204, the SP party determines whether modification of the configuration within computer 10 is desirable. If not, the SP party logs off server 30 and the process ends. Otherwise, a message is sent to server 30, in response to which server 30 makes available to the SP party a menu of configurations (encompassing applications and look-and-feel attributes). At step 206 the SP party makes its selections and sends a request to server 30 to effect the desired changes. In response, step 207 modifies the configuration of computer 10 and sends the modified configuration to computer 20.

The above-disclosed interaction between the SP party at computer 20 and server 30 can be in the form of server 30 presenting one or more web pages to computer 20 so that the SP party can make selections. Alternatively, computer 20 hosts local software that provides the menu and allows changes to be made to its local copy of the configuration for computer 10. Once the SP is satisfied with the modified configuration, the modified configuration is sent to server 30, and then to computer 10. Advantageously, server 30 offers both options to enable some SP parties to use the webpage approach, and other SP parties to use the local-software approach.

Once computer 20 receives the modified configuration information, step 208 permits the SP party at computer 20 to again emulate the environment of computer 10. Control then passes to step 209 where the SP party decides whether the emulated environment is acceptable. If not, the process step 209 sends a message to server 30 to return the process to step 205. Otherwise, step 209 sends a message to server 30 to advance the process to step 210. At step 210 server 30 downloads the modified configuration to computer 10 and causes computer 10 to install the downloaded changes.

FIG. 5 presents the process of configuring computer 10 without use of server 30. When the SP Party at computer 20 wishes to modify the configuration of computer 10, the SP Party initiates the FIG. 5 process, and in the first step the SP Party configures computer 10. The next step is a decision block where the SP Party determines whether the configuration of computer 10 is as desired. It so, the SP Party executes a configuration termination step.

In a first embodiment, the step of configuring computer 10 comprises the SP Party logging into computer 10 (remotely or locally) as an administrator, and making the desired changes. The configuration termination step consists of the SP Party logging out. In a second embodiment the step of configuring is performed with the aid of information that is stored in the computer of the SP Party, which information includes configuration data of computer 10, and with the aid of a software module within the SP Party computer that emulates the environment of computer 10. The configuration termination step comprises downloading at least the modified configuration data from the SP Party computer to computer 10.

It should be understood that the embodiments disclosed above are merely illustrative of the principles of this invention and that other implementations and equipment may be employed without departing from the spirit and scope of this invention. By way of illustration, a cell phone or a PDA serve the function of computer 10. A touch sensitive screen can replace the keyboard of computer 10, etc.

1. A system comprising:
at least one responder, where a responder is an element whose primary function is to output a signal in response to volitional triggering by an individual;
a processing element coupled to said at least one responder and to a data network, and including a first module for communicating information over a data network, and
a second module that is executed by said processing element and which causes an alert message to be sent by said first module over said data network when the execution of said second module reaches a determination that said triggering by said at least one responder represents an unexpected level of activity.

2. The system of claim 1 where said alert message is sent to more than one prespecified addressee.

3. The system of claim 1 wherein said determination is made pursuant to a set of rules.

4. The system of claim 3 wherein at least some rules in said set of rules are configurable.

5. The system of claim 3 wherein at least some rules in said set of rules are configurable via said data network.

6. The system of claim 3 where each of said rules pertains to a determination that said triggering is outside a predetermined range

7. The system of claim 6 where a rule of said rules includes a threshold and determination reaches a conclusion that said triggering is outside said predetermines range is in a preselected region determined by said threshold.

8. The system of claim 3 further comprising a third module that is executed by said processing element to configure at least one rule in said set of rules based on past usage of said system.

9. The system of claim 1 further comprising a device, coupled to said processing element, for outputting information to said individual.

10. The system of claim 1 where said device is a computer display

11. The system of claim 9 where said device is a ouch-sensitive display.

12. The system of claim 11 where said one or more responders are taken from a set that consists of keyboard, mouse, touch-sensitive screen, IR detector, microphone, camera.

13. The system of claim 9 further comprising a user program that is executed by said processing pursuant to said output signals from one or more of said at least one responder.

14. The system of claim 9 wherein said user program includes a capability to interact with remote entities over said data network.

15. The system of claim 9 wherein said user program is a social-networking program.

16. The system of claim 15 where said social-networking program is taken from a set that includes email, instant messaging, video phone calls, voice communication, web-based social networking sites, photo-sharing, and Internet searching.

17. The system of claim 1 further comprising
an information-storing module, coupled to said processing element, that contains configuration information; and
an overlay module, coupled to said processing element, that presents a user interface at said device for outputting information in accordance with dictates of said configuration information.

18. The system of claim 17 where said configuration information is downloaded to and installed in said information-storing module via said data network.

19. The system of claim 18 where said configuration information is downloaded and installed in said information-storing module by a computer that includes a module for simulating the user interface that said overlay module presents.

20. The system of claim 17 further comprising a service center server coupled to said system over via data network, where said server includes:
a service center configuration database that includes said configuration information for said system and configuration information for other systems;
a module for interacting with a computer of another party to modify said configuration information; and
a module for downloading and installing said configuration information in said information-storing module.

21. The system of claim 20 wherein said computer of another party includes a module for simulating user interface that said overlay module presents.

22. The system of claim 1 further comprising at least one opportunistic sensor coupled to said processing element, where an opportunistic sensor is an element whose primary functionality is to output a signal in response to non-volitional triggering, and where said second module causes an alert message to be sent by said first module over said data network when the execution of said second module reaches a determination that said triggering by said at least one responder or by said at least one opportunistic sensor is outside said predetermined range.

23. The system of claim 1 further comprising means for configuring said system via said data network.

24. A method executed in a processing device comprising the steps of with which a individual interacts comprising the steps of:
a module within said processing device, monitoring signals from a group of one or more responders associated with said processing device, to determine whether signals from said group are in violation of one or more rule of a set of rules, where a responder is an element that is employed by an individual to volitionally interact with said processing device; and
sending an alarm message over a data network to one or more specified addressees that reports on said violation.

25. A method for configuring a processing device comprising the steps of:
a first party, coupled to a data network through which said processing device is accessible, maintaining configuration data pertaining to said processing device;
a second party, coupled to said data network, causing changes to be made to said data; and
said first party installing said changes made to said data in said processing device.
